(19) United States
(12) Patent Application Publication
(10) Pub. No.: US 2025/0217741 A1
(43) Pub. Date: Jul. 3, 2025

(54) INFORMATION PROCESSING APPARATUS

(71) Applicant: TOYOTA JIDOSHA KABUSHIKI KAISHA, Toyota-shi (JP)

(72) Inventor: Shinichi NIWA, Nagoya-shi (JP)

(73) Assignee: TOYOTA JIDOSHA KABUSHIKI KAISHA, Toyota-shi (JP)

(21) Appl. No.: 18/999,186

(22) Filed: Dec. 23, 2024

(30) Foreign Application Priority Data
Dec. 28, 2023 (JP) 2023-223101

(51) Int. Cl. G06Q 10/0631; B60L 58/12

(52) U.S. Cl. CPC G06Q 10/06316; B60L 58/12; G06Q 10/06311; B60L 2240/622

(57) ABSTRACT

An information processing apparatus includes a communication interface, and a controller configured to communicate, using the communication interface, with a plurality of vehicles each of which has a schedule for executing a task, and transmit, upon receiving information indicating that a first task in a first time period cannot be executed as scheduled from a first vehicle, instruction information to cause at least one second vehicle that has a schedule for executing a second task with a lower priority than the first task for the first time period to execute the first task instead of the second task in place of the first vehicle.

### CROSS-REFERENCE TO RELATED APPLICATION

This application claims priority to Japanese Patent Application No. 2023-223101, filed on Dec. 28, 2023, the entire contents of which are incorporated herein by reference.

### TECHNICAL FIELD

The present disclosure relates to an information processing apparatus.

### BACKGROUND

As vehicles for various applications become more widespread, technologies have been proposed to assist in the control of vehicle operation. For example, Patent Literature (PTL) 1 discloses an in-vehicle apparatus that manages the execution of multiple tasks.

### CITATION LIST

### Patent Literature

PTL 1: JP 2020-197886 A

### SUMMARY

There is room to improve the certainty of task execution when each of a plurality of vehicles executes a task.

The present disclosure provides an information processing apparatus or the like that enables to improve the certainty of task execution by a plurality of vehicles.

An information processing apparatus in the present disclosure includes:
a communication interface; and
a controller configured to:
   communicate, using the communication interface, with a plurality of vehicles each of which has a schedule for executing a task; and
   transmit, upon receiving information indicating that a first task in a first time period cannot be executed as scheduled from a first vehicle, instruction information to cause at least one second vehicle that has a schedule for executing a second task with a lower priority than the first task for the first time period to execute the first task instead of the second task in place of the first vehicle.

According to the information processing apparatus or the like in the present disclosure, it is possible to improve the certainty of task execution by a plurality of vehicles.

### BRIEF DESCRIPTION OF THE DRAWINGS

In the accompanying drawings:

FIG. 1 is a diagram illustrating an example configuration of a vehicle management system;

FIG. 2 is a sequence diagram illustrating example operations of the vehicle management system;

FIG. 3 is a flowchart illustrating example operations of a server apparatus; and

FIG. 4 is a diagram illustrating an example of task comparison.

### DETAILED DESCRIPTION

An embodiment will be described below.

### <Configuration of Vehicle Management System>

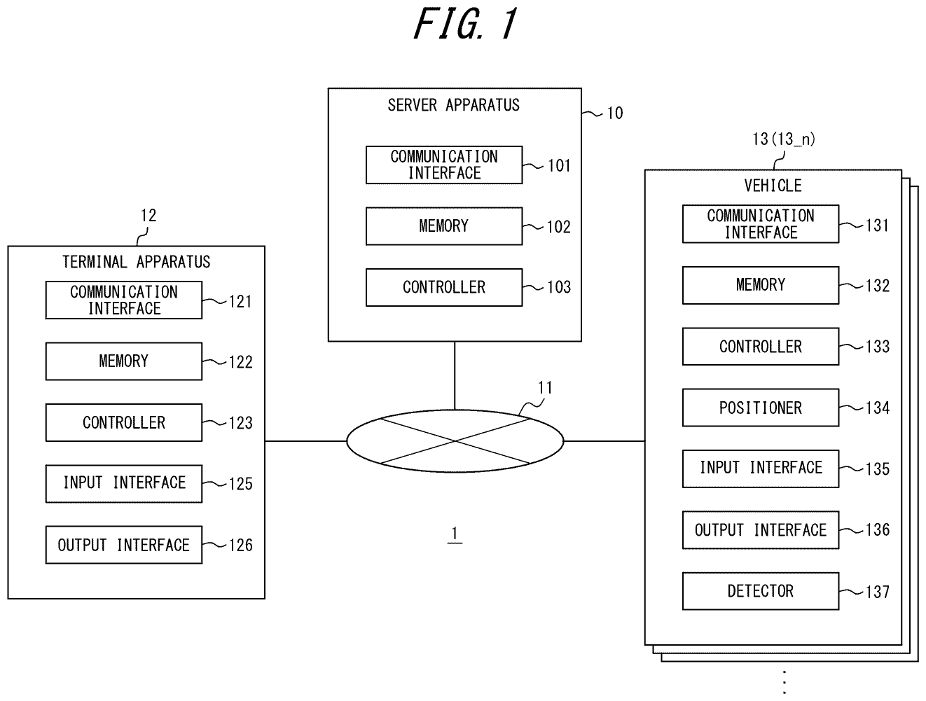

FIG. 1 is a diagram illustrating a configuration example of a vehicle management system 1 according to an embodiment. The vehicle management system 1 includes one or more server apparatuses 10, one or more terminal apparatuses 12, and a plurality of vehicles 13 communicably connected to each other via a network 11. The server apparatus 10 is, for example, a server computer that belongs to a cloud computing system or other computing system and functions as a server that implements various functions. The server apparatus 10 corresponds to an “information processing apparatus” in the present embodiment. The terminal apparatus 12 is an information processing terminal used by the operator of the vehicle management system 1, and exchanges various information with the server apparatus 10. The terminal apparatus 12 is, for example, a personal computer. The vehicles 13 are provided with communication functions and information processing functions and are connected to the network 11 via a mobile communication network. The vehicles 13 are, for example, multi-purpose bus vehicles with interior space or seats for transporting passengers and store facilities for selling products and providing services. The vehicle 13 may be driven by a driver, or driving may be automated at any level, such as one of Level 1 to Level 5 defined by the Society of Automotive Engineers (SAE). The vehicles 13 are each a battery electric vehicle (BEV) or a hybrid electric vehicle (HEV) that uses battery power for at least part of the energy for driving. In the following, when multiple vehicles 13 are distinguished from each other, they will be numbered as vehicle 13-n (n=1, 2, . . . ) and the branch number will be added. The network 11 may, for example, be the Internet or may include an ad hoc network, a local area network (LAN), a metropolitan area network (MAN), other networks, or any combination thereof.

In the present embodiment, the vehicle management system 1 manages and controls the execution of respective tasks by a plurality of vehicles 13. Tasks include, for example, transporting passengers as a bus vehicle and traveling sales and service as a mobile store. Each of the vehicles 13 executes a task by transporting passengers on any appropriate route in a certain time period, or by traveling and selling goods and other items in any appropriate area in another time period. The server apparatus 10 includes a communication interface 101 and a controller 103 that communicates via the communication interface 101. The controller 103 communicates, using the communication interface 101, with a plurality of vehicles 13 each of which has a schedule for executing a task, and transmits, upon receiving information indicating that a first task in a certain time period cannot be executed as scheduled from a vehicle 13-1 (herein after referred to as delay information), instruction information to cause at least one vehicle 13-2 that has a schedule for executing a second task with a lower priority than the first task for the time period to execute the first task instead of the second task in place of the vehicle 13-1. Thus, even if the execution of the first task is likely to be delayed by one vehicle 13-1, the first task can be executed instead of the second task with a lower priority, by a substitute vehicle 13-2. Thus, as a whole for multiple vehicles 13, it is possible to improve the certainty of execution of multiple tasks by multiple vehicles by more reliably executing tasks with higher priority.

### <Configuration of Server Apparatus 10>

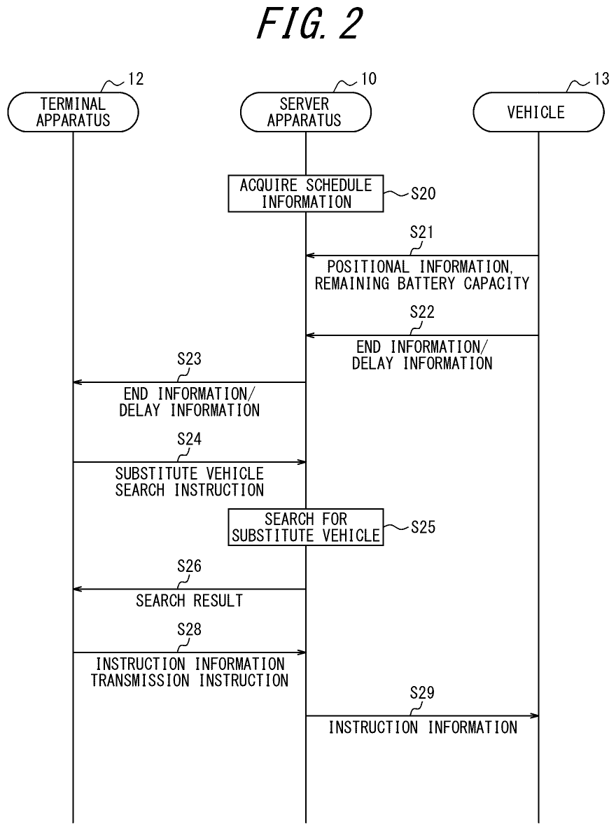

The server apparatus 10 includes the communication interface 101, a memory 102, and the controller 103. The server apparatus 10 is, for example, a single computer. The server apparatus 10 may be two or more computers that are communicably connected to each other and operate in cooperation. In this case, the configuration illustrated in FIG. 2 can be arranged among two or more computers as appropriate.

The communication interface 101 includes one or more interfaces for communication. The interface for communication is, for example, a LAN interface. The communication interface 101 receives information to be used for operations of the server apparatus 10 and transmits information obtained by the operations of the server apparatus 10. The server apparatus 10 is connected to the network 11 by the communication interface 101 and communicates information with the vehicles 13 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to the operations of the server apparatus 10 while controlling the components of the server apparatus 10.

The functions of the server apparatus 10 are realized by a processor included in the controller 103 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

### <Configuration of Terminal Apparatus 12>

The terminal apparatus 12 includes a communication interface 121, a memory 122, a controller 123, an input interface 125, and an output interface 126.

The communication interface 121 includes a communication module compliant with a wired or wireless LAN standard, a module compliant with a mobile communication standard such as Long Term Evolution (LTE), 4th Generation (4G), or 5th Generation (5G), or the like. The terminal apparatus 12 connects to the network 11 via a nearby router apparatus or mobile communication base station using the communication interface 121 and communicates information with other apparatuses over the network 11.

The memory 122 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for operations of the controller 123 and information obtained by the operations of the controller 123.

The controller 123 has one or more general purpose processors such as CPUs or micro processing units (MPUs) or one or more dedicated processors that are dedicated to specific processing. Alternatively, the controller 123 may have one or more dedicated circuits such as FPGAs or ASICs. The controller 123 is configured to perform overall control of operations of the terminal apparatus 12 by operating according to control/processing programs or operating according to operating procedures implemented in the form of circuits. The controller 123 then transmits and receives various types of information to and from the server apparatus 10 and the like via the communication interface 121, to execute operations according to the present embodiment.

The input interface 125 includes one or more interfaces for input. The interface for input includes, for example, a physical key, a capacitive key, a pointing device, a touch screen integrally provided with the display, a camera that captures images or image codes, or an IC card reader. The interface for input may include a microphone that accepts audio input. The input interface 125 accepts input of information to be used in the operations of the controller 123 and transmits the inputted information to the controller 123.

The output interface 126 includes one or more interfaces for output. The interface for output is, for example, a display or a speaker. The display is, for example, a liquid crystal display (LCD) or an organic electro-luminescent (EL) display. The output interface 126 outputs information obtained by the operations of the controller 123.

The functions of the controller 123 are realized by a processor included in the controller 123 executing a control program. The control program is a program for causing the processor to function as the controller 123. Some or all of the functions of the controller 123 may be realized by a dedicated circuit included in the controller 123.

### Configuration Example of Vehicle 13

The vehicle 13 includes a communication interface 131, a memory 132, a controller 133, a positioner 134, an input interface 135, an output interface 136, and a detector 137. One or more of these may be configured as a single control apparatus, or may be configured by a personal computer including a tablet terminal, a smartphone terminal, a navigation apparatus, or the like. Alternatively, each component may be connected via an in-vehicle network compliant with a standard such as controller area network (CAN) to enable communication of information.

The memory 132, the controller 133, the input interface 135, and the output interface 136 have configurations equivalent to those of the memory 122, the controller 123, the input interface 125, and the output interface 126 of the terminal apparatus 12, respectively.

The communication interface 131 includes one or more interfaces for communication. Examples of the interface for communication include an interface corresponding to mobile communication standards, such as LTE, 4G, or 5G. The communication interface 131 receives information to be used for the operations of the controller 133 and transmits information obtained by the operations of the controller 133. The controller 133 connects to the network 11 using the communication interface 131 through a mobile communication base station and communicates information with other apparatuses via the network 11.

The positioner 134 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. Based on the information acquired by the positioner 134, the positional information for the vehicle 13 is obtained.

The detector 137 interfaces with or has one or more sensors that detect the status of various parts of the vehicle 13. The sensors include, for example, sensors that detect the remaining battery capacity of the vehicle 13 and sensors that detect the state of motion of the vehicle 13 (speed, forward/backward acceleration, left/right acceleration, deceleration, etc.). The detector 137 transmits information indicating each state detected by the sensor to the controller 133.

The controller 133 controls each of the communication interface 131, the memory 132, the positioner 134, the input interface 135, the output interface 136, and the detector 137 while exchanging various information with these components and also controls the operation of the vehicle 13. At the time of operating the vehicle 13, the controller 133 controls the operation of the vehicle 13 by presenting various information necessary for the operation to the driver via the output interface 136 and/or by controlling the automatic operation of the vehicle 13.

### <Operations of Vehicle Management System 1>

FIG. 2 is a sequence diagram illustrating an example procedure for coordinated operations of the server apparatus 10, the terminal apparatus 12, and the vehicles 13. The steps pertaining to the various information processing by the server apparatus 10, the terminal apparatus 12, and the vehicles 13 in FIG. 2 are performed by the respective controllers 103, 123, 133. The steps pertaining to transmitting and receiving various types of information to and from the server apparatus 10, the terminal apparatus 12, and the vehicles 13 are performed by the respective controllers 103, 123, 133 transmitting and receiving information to and from each other via the respective communication interfaces 101, 121, 131. In the server apparatus 10, the terminal apparatus 12, and the vehicles 13, the respective controllers 103, 123, 133 appropriately store the information that is processed, transmitted and received in the respective memories 102, 122, 132.

The procedure in FIG. 2 is an example of a procedure when an operator uses the terminal apparatus 12 to manage and control the task execution in the vehicles 13 via the server apparatus 10.

In step S20, the server apparatus 10 acquires schedule information for each of the plurality of vehicles 13. The schedule information includes information such as the type of task, the scheduled start and end time of the task, and the location where the task will be executed. The schedule information may be stored by each vehicle 13 and transmitted from the vehicle 13 to the server apparatus 10, or the schedule information for each vehicle 13 may be stored in the server apparatus 10 and read by the controller 103. Alternatively, the schedule information of any vehicle 13 may be sent to the server apparatus 10 by the operator entering the schedule information of any vehicle 13 to the terminal apparatus 12, as appropriate. Step S20 is performed once a day, for example.

In step S21, the server apparatus 10 receives positional information and battery information from each vehicle 13. Step S21 is performed in any appropriate cycles, for example, in cycles of several seconds to several tens of seconds.

In step S22, the server apparatus 10 receives progress information from each vehicle 13. The progress information is information indicating the progress of tasks in each of the vehicles 13. The progress information includes end information or delay information. The end information indicates the end of each task. For example, when the crew of the vehicle 13 confirms the end of one task, they make an input to the input interface 135 indicating the end of the task, and the controller 133 generates end information in response to the input. Alternatively, the controller 133 may generate end information when a predetermined condition is met according to any algorithm. On the other hand, the delay information indicates that the completion of one task is delayed and therefore subsequent tasks will not be executed as scheduled. For example, if the crew of the vehicle 13 recognizes that it is difficult to end the task at the scheduled end time, they make an input to the input interface 135 indicating the difficulty in completion, and the controller 133 generates delay information in response to the input. Alternatively, the controller 133 may transmit delay information when predetermined conditions are met according to any algorithm. For example, the controller 133 may determine a termination difficulty when the vehicle 13 is not in the reference state at any reference time before the scheduled end time of a task, e.g., a few minutes to a dozen minutes before the scheduled end time. For example, the reference state is that the vehicle 13 is located at the transport destination or at any distance therefrom, or at the end point of the patrol or at any distance therefrom. When the reference state relates to the position of the vehicle 13, the reference time may be moved forward or backward depending on the distance between the current position of the vehicle and the position defined by the reference state. In a variation, the scheduled completion of a task or difficulty in completing a task as scheduled may be determined at the server apparatus 10 based on the scheduled information and current location of the vehicle 13.

In step S23, the server apparatus 10 transmits progress information including end information or delay information to the terminal apparatus 12. Once the end information is transmitted, step S24 and thereafter are omitted. Once the delay information is transmitted, step S24 is performed.

In step S24, the server apparatus 10 receives a substitute vehicle search instruction from the terminal apparatus 12. The substitute vehicle search instruction is an instruction that causes the server apparatus 10 to search for another vehicle 13-2 that executes the task of one vehicle 13-1 in place of the vehicle 13-1. In the vehicle 13-1, if the completion of a task is delayed, there is a large probability that subsequent tasks will not start as scheduled (hereinafter, tasks that cannot start as scheduled are referred to as delayed tasks). The substitute vehicle 13-2 is a vehicle to execute the delayed task of the vehicle 13-1 in place of the vehicle 13-1. The delayed task may be the task immediately following the task whose termination is delayed, or it may be a task further behind. At the terminal apparatus 12, when the delay information is output, the operator who has confirmed the delay information performs an operation to instruct the search for a substitute vehicle. In response to that operation, the terminal apparatus 12 transmits a substitute vehicle search instruction to the server apparatus 10.

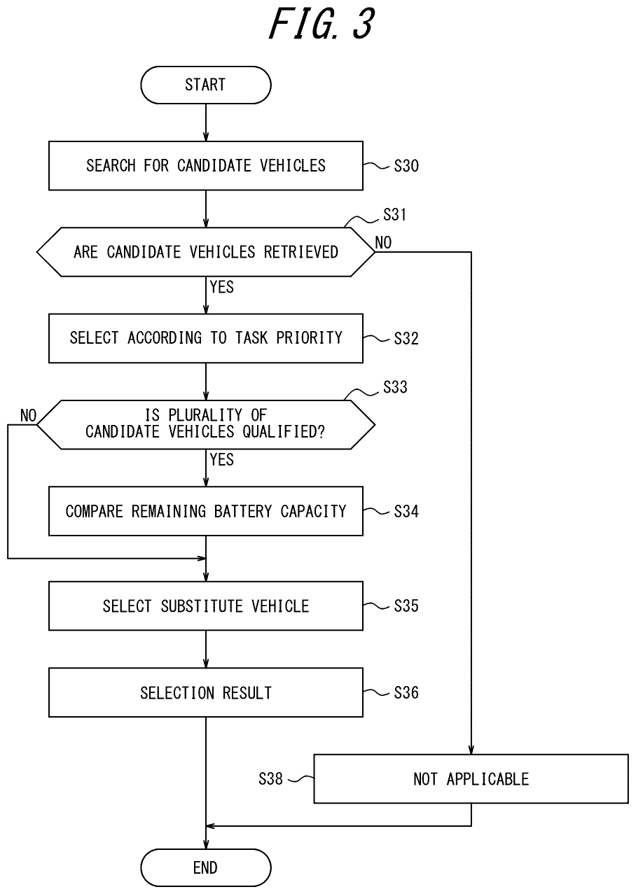

In step S25, the server apparatus 10 executes a substitute vehicle search in response to the substitute vehicle search instruction. Details of step S25 are illustrated in FIG. 3.

FIG. 3 is a flowchart illustrating an example operation procedure for the server apparatus 10 that performs the substitute vehicle search. Each step in FIG. 3 is executed by the controller 103.

In step S30, the controller 103 searches for candidate vehicles to be candidates for the substitute vehicle. The candidate vehicles are the vehicles 13 for which schedule information and positional information are acquired in the controller 103. In a case in which one or more candidate vehicles have been retrieved (Yes in step S31), the controller 103 proceeds to step S32, whereas otherwise (No in step S31), the controller 103 proceeds to step S38.

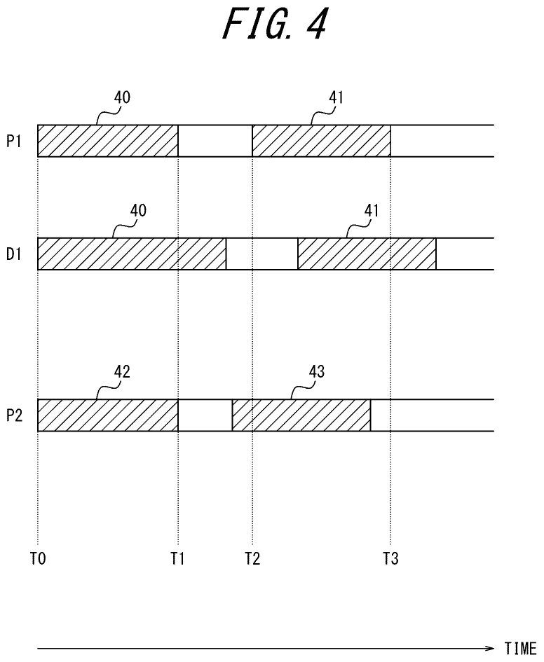

In step S32, the controller 103 selects candidate vehicles that are qualified as the substitute vehicle according to the task priority. FIG. 4 illustrates an example of task comparison. FIG. 4 schematically illustrates the schedule or progress of a task with the horizontal axis being the time axis. For example, an original schedule P1 for the vehicle 13-1, progress DI where delays have occurred, and an original schedule (or, in this case, the progress where no delays have occurred) P2 for the vehicle 13-2. In the schedule P1 for the vehicle 13-1, a task 40 is scheduled for the time period of times T0 to T1, the predetermined interval is scheduled for times T1 to T2, and the subsequent task 41 is scheduled for the time period of times T2 to T3. The progress DI indicates that the task 41 after the interval from the times T1 to T2 cannot be started at the scheduled start time T2 because the end of the task 40 was later than the scheduled end time T1 for some reason, such as traffic congestion, machine trouble, or human error. In the schedule P2 for the vehicle 13-2, along with a task 42, a task 43 is scheduled for the time period when the delayed task 41 of the vehicle 13-1 was originally scheduled, i.e., the time period overlapping with the times T2 to T3. For example, the controller 103 compares the priority of the delayed task 41 in the vehicle 13-1 with the priority of the task 43 in the vehicle 13-2 (hereinafter referred to as the comparison task) when the time when the substitute vehicle search instruction is received is before the scheduled start time of the task 43. The controller 103 then determines that the vehicle 13-2 is qualified as a substitute vehicle if the priority of the comparison task 43 is lower than the priority of the delayed task 41, and otherwise determines that the vehicle 13-2 is ineligible as a substitute vehicle.

Information on the priority of tasks for the vehicles 13 may be included in the schedule information for each of the vehicles 13, or a table mapping tasks to priorities may be stored in the memory 102 in advance. Alternatively, priority information may be sent by the terminal apparatus 12. The higher the priority, for example, the greater the number of users affected by the task. The number of users affected by the task is, for example, the number of users expected to be transported, the number of users expected to use traveling sales and services, etc. Alternatively, the priority can be set arbitrarily according to the attributes of the user affected by the task. For example, if the vehicle 13 patrols the premises of a company or factory, the highest number of users expected to use the transport or sales and service are outside the company, the priority is higher than for internal users.

If the controller 103 determines that multiple candidate vehicles 13 are qualified as the substitute vehicle according to the task priority as described above (Yes in step S33), it proceeds to step S34, and if it determines that one candidate vehicle 13 is qualified as the substitute vehicle (No in step S33), it skips step S34 and proceeds to step S35.

In step S34, the controller 103 compares the remaining battery capacity of the multiple candidate vehicles 13 determined to be qualified as the substitute vehicle and selects the vehicle 13 with the largest remaining battery capacity as the most qualified substitute vehicle. In variation, the controller 103 may select the most qualified substitute vehicle using the current location of the vehicle 13 instead of the remaining battery capacity. For example, the vehicle 13 closest to the scheduled start location of the delayed task could be selected as the most qualified substitute vehicle.

In step S36, the controller 103 generates information on the selection result. The selection result includes information identifying the selected substitute vehicle 13. The controller 103 then terminates the process of FIG. 3.

On the other hand, in step S38, the controller 103 generates information indicating not applicable. The information indicating not applicable is information indicating that no candidate vehicles exist. The controller 103 then terminates the process of FIG. 3.

Returning to FIG. 2, in step S26, the server apparatus 10 transmits the search result for the substitute vehicle to the terminal apparatus 12. The search result includes the selection result that identify the substitute vehicle, or the information indicating not applicable.

In step S28, the server apparatus 10 receives an instruction to transmit instruction information from the terminal apparatus 12. The instruction information is information that includes instructions for the substitute vehicle 13-2 to execute the delayed task 41 of the vehicle 13-1 instead of the comparison task 43. The instruction information includes the start time of the task, the type of task, the equipment required for the task, the starting point of the task, and other information necessary to execute the delayed task 41. At the terminal apparatus 12, when the selection result of the substitute vehicle is output as a search result, the operator who has confirmed the selection result performs an operation to instruct the substitute vehicle to execute the delayed task. In response to the operation, the terminal apparatus 12 generates and transmits instructions for transmitting instruction information to the server apparatus 10. When a search result indicating not applicable is output, the operator confirms not applicable and the procedure of FIG. 2 is terminated.

In step S29, the server apparatus 10 transmits the instruction information to the substitute vehicle 13-2. Then, in response to the instruction information, the vehicle 13-2 executes the delayed task.

According to the procedure described above, even if a delayed task in one vehicle 13-1 occurs, a substitute vehicle 13-2 can be used to execute the delayed task instead of a comparison task with a lower priority. Thus, as a whole for the multiple vehicles 13, it is possible to improve the certainty of task execution by more reliably executing tasks with a higher priority.

In a variation, when a delayed task is generated by a subsequent task due to a delay in the completion of the current task in the vehicle 13, the vehicle 13 may be instructed to abort the current task and execute the delayed task as scheduled from the server apparatus 10, provided that the priority of the delayed task is higher than the priority of the current task.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising:
a communication interface; and
a controller configured to:
communicate, using the communication interface, with a plurality of vehicles each of which has a schedule for executing a task; and
transmit, upon receiving information indicating that a first task in a first time period cannot be executed as scheduled from a first vehicle, instruction information to cause at least one second vehicle that has a schedule for executing a second task with a lower priority than the first task for the first time period to execute the first task instead of the second task in place of the first vehicle.

2. The information processing apparatus according to claim 1, wherein the controller is configured to receive information on schedules of tasks from the plurality of vehicles.

3. The information processing apparatus according to claim 1, wherein the controller is configured to generate the instruction information using information on a priority of a task for each of the plurality of vehicles.

4. The information processing apparatus according to claim 1, wherein
the at least one second vehicle is a plurality of second vehicles, and
the controller is configured to:
receive information on remaining battery capacity of each vehicle from the plurality of vehicles; and
transmit the instruction information to a vehicle with larger remaining battery capacity than other vehicles among the plurality of second vehicles.

5. The information processing apparatus according to claim 1, wherein
the at least one second vehicle is a plurality of second vehicles, and
the controller is configured to:
receive positional information for each vehicle from the plurality of vehicles; and
transmit the instruction information to a vehicle a distance from which to a point to start executing the first task is less than other vehicles among the plurality of second vehicles.
